(19) United States
(12) Patent Application Publication
(10) Pub. No.: US 2007/0155859 A1
(43) Pub. Date: Jul. 5, 2007

(54) Reactive polyurethane hot melt adhesive

(76) Inventors: Zhengzhe Song, Vernon Hills, IL (US); Yingjie Li, Batavia, IL (US); Jason D. Smith, Elgin, IL (US)

Correspondence Address: HENKEL CORPORATION, THE TRIAD, SUITE 200, 2200 RENAISSANCE BLVD., GULPH MILLS, PA, 19406, US

(21) Appl. No.: 11/325,117

(22) Filed: Jan. 4, 2006

(51) Int. Cl. C08J 9/32

(52) U.S. Cl. 523/218

(57) ABSTRACT

Hot melt polyurethane adhesive compositions which are solid at room temperature and capable of being cured by moisture are obtained by combining isocyanate-functionalized polyurethane prepolymers and hollow polymeric microspheres. The adhesive compositions exhibit enhanced green strength, shortened open time and reduced densities as compared to analogous adhesives that are not modified with hollow polymeric microspheres.

### FIELD OF THE INVENTION

This application relates to a moisture-curing polyurethane hot melt adhesive containing a plurality of polymeric hollow microspheres, to its production and to its use.

### BACKGROUND OF THE INVENTION

Moisture-curing or moisture-crosslinking polyurethane hot melt adhesives are adhesives which are solid at room temperature and which are applied in the form of a melt, their polymeric constituents containing urethane groups and reactive isocyanate groups. Cooling of the melt results initially in rapid physical setting of the adhesive followed by a chemical reaction of the isocyanate groups still present with moisture to form a cross-linked, infusible adhesive. It is only after this chemical curing with moisture, accompanied by an increase in the size of the molecules and/or crosslinking, that the adhesive acquires its final properties.

Although a large number of different reactive polyurethane hot melt adhesives have been developed over the last few decades, workers in the field have recognized that further improvements in certain properties would be desirable to achieve in order to tailor the characteristics of such adhesives to particular end use applications. In particular, the development of reactive polyurethane hot melt adhesive systems having enhanced green strength properties would be advantageous, since this would permit the attainment of greater efficiency in the production of assemblies involving the joining of substrates.

### BRIEF SUMMARY OF THE INVENTION

The invention provides a largely or entirely solvent-free moisture-curing polyurethane hot melt composition which is solid at room temperature comprising an isocyanate-functionalized polyurethane prepolymer and a plurality of hollow polymeric microspheres. The presence of the hollow polymeric microspheres significantly shortens the open time and solidification time of the adhesive. The rapid solidification of the melted adhesive upon cooling results in the adhesive having high initial adhesive strength and cohesive strength (i.e., high green strength). At the same time, the density of the adhesive is reduced dramatically, even when only relatively small amounts of the microspheres are present.

### DETAILED DESCRIPTION OF CERTAIN EMBODIMENTS OF THE INVENTION

As previously noted, the reactive polyurethane hot melt adhesives of the present invention contain a plurality of hollow polymeric microspheres. Preferably, the microspheres are already expanded when combined with the isocyanate-functionalized polyurethane prepolymer and other components of the hot melt adhesive, although expandable microspheres could alternatively be utilized. It is also preferred for the outer surfaces of the hollow polymeric microspheres to be covered with an adherent coating of a surface barrier material (e.g., a surface barrier solid, a surface barrier liquid or a mixture of a surface barrier liquid with a surface barrier solid). Microspheres having such adherent coatings generally have free flowing properties and are sometimes referred to in the art as thermally clad microspheres.

Although the size of the microspheres is not believed to be particularly critical, typically the microspheres useful in the present invention will have diameters of from about 5 microns to about 500 microns. In one embodiment, the particle size (diameter) of the microspheres is from about 20 to about 60 microns. Similarly, the precise density of the microspheres selected for use is not thought to be especially important, although generally speaking the microsphere density will not be greater than about 0.04 g/cm³. When an adherent coating is present on the outer surface of the microspheres, the microsphere density may be calculated from the measured composite density using the known weight ratios of the microspheres and surface barrier material(s) used to prepare the coated microspheres. In one embodiment of the invention, the microsphere composite density is less than about 0.6 g/cm³ or less than about 0.3 g/cm³ (e.g., from about 0.09 to about 1.9 g/cm³).

Methods of preparing expandable hollow polymeric microspheres are well-known in the art and are described, for example, in the following United States patents and applications, each of which is incorporated herein by reference in its entirety: U.S. Pat. Nos. 3,615,972; 3,864,181; 4,006,273; 4,044,176; 6,235,394; 6,509,384; 6,235,800; 5,834,526; 5,155,138; 5,536,756; 6,903,143; 6,365,641; and 2005-0080151.

Methods of expanding hollow polymeric microspheres containing blowing agents are also well-known in the art and are described, for example, in certain of the patents mentioned in the immediately preceeding paragraph as well as the following United States patents and applications, each of which is incorporated herein by reference in its entirety: U.S. Pat. No. 5,484,815 and 2004-0176487. Where the expandable hollow polymeric microspheres are in the form of a wet cake, drying of the microspheres can be carried out together with microsphere expansion.

The preparation of hollow polymeric microspheres containing an adherent outer coating of a barrier material (e.g., thermally clad hollow polymeric microspheres) is also well-known in the art, as described, for example, in the following United States patents and applications, each of which is incorporated herein by reference in its entirety: U.S. Pat. Nos. 4,722,943; 4,829,094; 4,843,104; 4,888,241; 4,898,892; 4,898,894; 4,908,391; 4,912,139; 5,011,862; 5,180,752; 5,580,656; 6,225,361; 5,342,689; and 2005-0282014. As described in certain of the aforementioned patents, coating of the microspheres may be carried concurrently or sequentially in coordination with drying and expansion.

Hollow polymeric microspheres can be made from a rather wide diversity of thermoplastic polymers (including crosslinked thermoplastic polymers) as well as thermoset polymers. In at least certain embodiments of the invention, the microspheres are comprised of one or more polymeric materials which are homopolymers or copolymers (it being understood that this term includes terpolymers, tetrapolymers, etc.) of one or more monomers selected from the group consisting of vinylidene chloride and acrylonitrile (wherein the vinylidene chloride and acrylonitrile may be copolymerized with each other and/or with other types of ethylenically unsaturated monomers).

Suitable polymers for the formation of hollow polymeric microspheres for use in the present invention include materials which are effective vapor barriers to the blowing agent at expansion temperatures, and which have adequate physical properties to form self-supporting expanded microspheres. It will also be desirable to select polymers that have softening and/or melting points sufficiently high to resist significant permanent deformation or collapse of the hollow polymeric microspheres as the hot melt adhesive compositions are processed and used (e.g., subjected to heating). For example, the hollow polymeric microspheres preferably are stable at temperatures of at least about 140° C., or at least about 160° C., or alternatively at least about 180° C. “Stable” in this context means that the hollow polymeric microspheres exhibit essentially no permanent collapse or deformation (it being understood that the stable microspheres may be temporarily deformable, particularly if the adhesive containing the microspheres is subjected to relatively high shear at an elevated temperature). The characteristics of the microspheres should be selected to be compatible with the properties and expected use temperature of the reactive polyurethane hot melt adhesive in which the microspheres are to be incorporated. For example, if the adhesive is relatively high melting or is to be stored and/or applied to a substrate at a relatively high temperature, it will generally be desirable to select a polymer or copolymer for use in forming the microsphere that is highly heat resistant (e.g., has a high softening or melting point). The heat resistance of the hollow polymeric microspheres can also be influenced by the type of barrier material coated on the outer surfaces of the microspheres.

The microspheres useful in the present invention may be manufactured using polymers obtained by polymerizing one or more ethylenically unsaturated monomers such as vinylidene chloride, vinylidene dichloride, vinyl chloride, acrylonitrile, methacrylonitrile, alkyl acrylates and alkyl methacrylates, including methyl methacrylate, methyl acrylate, butyl acrylate, butyl methacrylate, isobutyl methacrylate, stearyl methacrylate, and other related acrylic monomers such as 1,3-butylene dimethacrylate, allyl methacrylate, trimethylolpropane trimethacrylate, trimethylolpropane triacrylate, 1,4-butanediol dimethacrylate, 1,3-butanediol dimethacrylate, isobornyl methacrylate, dimethylaminoethyl methacrylate, hydroxyethyl methacrylate, hydroxypropyl methacrylate, diurethane dimethacrylate, and ethylene glycol dimethacrylate. Other monomers such as, for example, vinyl aromatic compounds, olefins and the like, may be included in the polymer, typically in minor proportions.

The monomers used to prepare the polymer may comprise multifunctional monomers which are capable of introducing crosslinking. Such monomers include two or more carbon-carbon double bonds per molecule which are capable of undergoing addition polymerization with the other monomers. Suitable multifunctional monomers include divinyl benzene, di(meth)acrylates, tri(meth)acrylates, allyl (meth)acrylates, and the like. If present, such multifunctional monomers preferably comprise from about 0.1 to about 1 weight percent or from about 0.2 to about 0.5 weight percent of the total amount of monomer. In one embodiment, the thermoplastic is a terpolymer of acrylonitrile, vinylidene chloride and a minor proportion (normally less than 5% by weight) of divinyl benzene. Microspheres comprised of this preferred terpolymer are commercially available from Sovereign Specialty Chemicals (now part of Henkel Corporation).

In another embodiment, the polymer is a copolymer containing 0-80% by weight vinylidene chloride, 0-75% by weight acrylonitrile, and 0-70% by weight methyl methacrylate. In still another embodiment, the polymer is prepared by copolymerization of 0-55% by weight vinylidene chloride, 40-75% by weight acrylonitrile, and 0-50% by weight methyl methacrylate. For example, the polymer may be a methyl methacrylate-acrylonitrile copolymer, a vinylidene chloride-acrylonitrile copolymer or a vinylidene chloride-acrylonitrile-methyl methacrylate copolymer.

In one preferred embodiment of the invention, the hollow polymeric microspheres are thermally clad with an outer adherent coating of at least one solid particulate material selected from the group consisting of pigments, reinforcing fillers, and reinforcing fibers, such as those conventionally used in polymer formulations. For example, talc, calcium carbonate (including colloidal calcium carbonate), barium sulfate, alumina (e.g., alumina tri-hydrate), silica, titanium dioxide, zinc oxide, and the like may be employed. Other materials of interest include spherical beads, or hollow beads of ceramics, quartz, glass or polytetrafluoroethylene, or the like. Among the fibrous materials of interest are glass fibers, cotton flock, polyamide fibers, particularly aromatic polyamide fibers, carbon and graphite fibers, metallic fibers, ceramic fibers, and the like. Conductive surface particulate coatings, such as conductive carbon, copper or steel fibers, and organic fibers with conductive coatings of copper or silver or the like are also of particular use. The solid particulate material (sometimes also referred to in the microsphere art as a solid processing aid or solid barrier material) typically is relatively small in size, i.e., is a finely divided solid. The particle size is not believed to be especially critical, but generally will be smaller on average than the average particle size of the hollow polymeric microspheres on which the particles coated. For example, the solid particulate material may have an average particle size of at least about 0.01 microns or about 0.1 microns and not greater than about 10 microns or about 5 microns. The particles may be regular or irregular in shape, e.g., spherical, rod-like, fibrous, platelet, and so forth. In certain embodiments, at least a portion of the solid particulate solid material is embedded and/or bound to the outer surfaces of the microspheres. This can be accomplished, for example, by heating expandable microspheres coated with the solid particulate material at a temperature effective to soften the polymer shells of the microspheres, allowing the microspheres to expand, and then cooling the microspheres below the softening point of the polymer, thereby allowing the particles of the solid barrier material to become physically attached to the microsphere outer surface (such microspheres are sometimes referred to in the art as having thermally clad or thermally bound coatings).

Expanded microspheres having an adherent coating of barrier material suitable for use in the present invention are commercially available, including the microspheres sold by Sovereign Specialty Chemicals, Inc. (now part of Henkel Corporation) under the brand name DUALITE.

The hot melt adhesive compositions of the present invention additionally contain at least one isocyanate-functionalized polyurethane prepolymer. An “isocyanate-functionalized polyurethane prepolymer” is understood to be an oligourethane containing reactive isocyanate groups which is formed by the reaction of hydroxyfunctional compounds with a more than stoichiometric quantity of polyisocyanates, thus resulting in compounds with free (reactive) isocyanate groups. Polyisocyanates in this context are preferably low molecular weight compounds containing two isocyanate groups, although they may contain up to 10% by weight of trifunctional and/or higher functional isocyanate. However, unwanted crosslinking may be observed both in the production and in the use of the hot melt adhesive if the amount of polyisocyanates with functionality of three or more is too high.

Although aromatic polyisocyanates are the most preferred isocyanates, aliphatic and/or cycloaliphatic polyisocyanates may also be used.

Examples of suitable aromatic polyisocyanates include: any isomers of toluene diisocyanate (TDI) either in the form of pure isomers or in the form of a mixture of several isomers, naphthalene-1,5-diisocyanate (NDI), naphthalene-1,4-diisocyanate (NDI), 4,4′-diphenylmethane-diisocyanate (MD[), 2,4′-diphenylmethane-diisocyanate (MDI), xylylenediisocyanate (XDI), 2,2-diphenylpropane-4,4′-diisocyanate, p-phenylene diisocyanate, m-phenylene diisocyanate, diphenyl4,4′-diisocyanate, diphenylsulphone-4,4′-diisocyanate, 1-chlorobenzene-2,4-diisocyanate, 4,4′,4″-triisocyanato-triphenyl-methane, 1,3,5-triisocyanato-benzene, 2,4,6-triisocyanato-toluene and furfurylidene diisocyanate. Examples of suitable cycloaliphatic polyisocyanates include 4,4′-dicyclohexylmethane diisocyanate (H₁₂MDI), 3,5, 5-trimethyl-3-isocyanatomethyl-1-isocyanato-cyclohexane (isophorone-diisocyanate, IPDI), cyclohexane-1,4-diisocyanate, cyclohexane-1,2-diisocyanate, hydrogenated xylylene diisocyanate (H₆XDI), m- or p-tetramethylxylylene diisocyanate (m-TMXDI, p-TMXDI) and diisocyanate from dimer acid. Examples of aliphatic isocyanates include hexane-1,6-diisocyanate (HDI), 2,2,4-trimethylhexane-1,6-diisocyanate, 2,4,4-trimethylhexane-1,6-diisocyanate, butane-1,4-diisocyanate and 1,12-dodecane diisocyanate (C₁₂DI). Liquid mixtures of 4,4′-diphenylmethane-diisocyanate and 2,4′-diphenylmethane-diisocyanate are used as the polyisocyanate in certain embodiments of the invention.

Under certain conditions it may be advantageous to use mixtures of the above mentioned polyisocyanates.

Hydroxyfunctional compounds (i.e., “polyols”) for making the polyurethane prepolymer may be selected, for example, from polyetherpolyols, polyester polyols and/or aromatic polyols.

A “polyether polyol” is understood to be a polyether (preferably linear, although branched polyethers may also be used) containing at least two OH groups. The preferred polyether polyols are diols corresponding to the general formula HO(—R—O)ₘ—H, where R is a hydrocarbon radical containing 2 to 4 carbon atoms (e.g., ethylene, propylene, butylenes) and m is in the range from 4 to 225 on average. Specific examples of such polyether polyols include polyethylene glycol, polybutylene glycol, polytetramethylene glycol (polyTHF) and polypropylene glycol (R═—CH₂CH(CH₃)—). Such polyether polyols may be prepared by known methods such as, for example, polymerization of one or more cyclic ether monomers such as ethylene oxide, propylene oxide, n-butene oxide, and tetrahydrofuran, either alone or in combination with each other. The polyether polyols may be used both as homopolymers and as copolymers (e.g., block copolymers as well as statistical (random) copolymers). In one embodiment of the invention just one type of polyether polyol is used, although in other embodiments mixtures of 2, 3 or more polyether polyols differing in their average molecular weight and/or in the nature of their structural elements are used. In certain embodiments, small quantities of one or more trifunctional polyether polyol (i.e., a polyether triol) may also be present in the mixture. The average molecular weight (number average molecular weight) of the polyether polyols may, for example, be in the range from 200 to 10,000 or in the range from 400 to 6,000.

A “polyester polyol” is understood to be a polyester having more than 1 OH group, preferably at least 2 terminal OH groups. Such polyesters may be prepared by known routes, such as by condensation polymerization of aliphatic hydroxycarboxylic acids or condensation copolymerization of aliphatic and/or aromatic dicarboxylic acids and diols (e.g., glycols).

Of course, other appropriate derivatives may be used, e.g., lactones, methyl esters or anhydrides. Specific starting materials include: 1,4-butanediol, 1,6-hexanediol, 1,10-decanediol, 1,12-dodecanediol, adipic acid, azelaic acid, sebacic acid, 1,10-decanedicarboxylic acid and lactones. The acid component may, in certain embodiments, include up to 25% on a molar basis of other acids, for example, cyclohexanedicarboxylic acid, terephthalic acid and/or isophthalic acid. The glycol component may,in certain embodiments, include up to 15% on a molar basis of other diols, for example, diethylene glycol and 1,4-cyclohexanedimethanol. In addition to homopolymers obtained from the above components, copolyesters from the following components or derivatives thereof may also be utilized:
1. adipic acid, isophthalic acid, phthalic acid, and butanediol;
2. adipic acid, phthalic acid and hexanediol;
3. adipic acid, isophthalic acid, phthalic acid, ethylene glycol, neopentylglycol, and 3-hydroxy-2,2-dimethylpropyl-3-hydroxy-2,2-dimethyl propanoate;
4. adipic acid, phthalic acid, neopentylglycol, and ethylene glycol; and
5. adipic acid and hexanediol.

The copolyester from adipic acid, isophthalic acid, phthalic acid, and butanediol is partially crystalline and has a high viscosity. Hence, it results in high initial strength. The copolyester from adipic acid, phthalic acid and hexanediol has low glass transition temperature and therefore, results in improved low-temperature flexibility.

The suitable polyester polyols may optionally be lightly branched, i.e., small quantities of a tricarboxylic acid or trihydric alcohol may be used in their production.

The polyester polyols can be either liquid or solid. In case they are solid, they are preferably amorphous. However, they can be weakly crystalline as well. In one embodiment, a mixture of partially crystalline and amorphous polyester polyols is employed. However, crystallinity preferably is developed so weakly that it does not become noticeable as opaqueness in the final hot-melt adhesive. The melting point of the partially crystalline polyester can be in the range of from 40 to 70° C., preferably in the range of from 45 to 65° C. The melting point indicates the temperature at which the crystalline regions of the material will melt. It is determined by differential thermoanalysis through the main endothermic peak. In one embodiment, a polyhexanediol adipate having a number average molecular weight of about 3000 to about 4000 and a melting point of about 60° C. is used as the partially crystalline polyester glycol. A polybutanediol adipate having a number molecular weight of about 3000 to about 4000 and a melting point of about 50° C. can also be used as the partially crystalline polyester glycol.

The average molecular weight (Mn) of the polyester polyol can, for example, be between 1,500 and 30,000, alternatively between 2,500 and 6,000. The number average molecular weight can be calculated from the OH number. The molecular weight of the polyester polyol is of some significance: A relatively high molecular weight makes extrusion of the hot-melt adhesive and penetration into porous substrates more difficult, and a relatively low molecular weight may result in the hot-melt adhesive not being sufficiently solid at room temperature.

The polyester polyols may have a glass transition temperature (Tg) in the range of preferably from −40° C. to +50° C. and, in particular, in the range of from −40° C. to +40° C. The Tg is determined on the basis of DSC measurements as the center point of the step using a ratio of 10° C./min in the second run.

Particularly suitable polyester polyols include those having a glass transition temperature of about −40° C. to +40° C., a viscosity of 3,000 to 30,000 mPa·s at 130° C. (Brookfield, RVDV II+Thermosel) and a hydroxyl number of 2 to 80, preferably 2 to 40 mg KOH/g.

An “aromatic polyol” is understood to be an alkoxylation product of an aromatic polyhydroxy compound. These are, in particular, the reaction products of ethylene oxide and/or propylene oxide with aromatic dihydroxy compounds such as, for example, hydroquinone, resorcinol, pyrocatechol, bis-(hydroxydiphenyl), bisphenol A, bisphenol F, isomers of dihydroxynaphthalene (pure isomers or a mixture of several isomers), isomers of dihydroxyanthracene (pure isomer or isomer mixture) or isomers of dihydroxyanthraquinone. One to seven alkoxy units per aromatic hydroxy group are typically added (reacted).

The prepolymer may also be prepared using one or more active hydrogen-functionalized thermoplastic resins, such as the hydroxy-functionalized acrylic resins obtained by the polymerization of hydroxyalkyl acrylates and methacrylates (including the copolymerization of such monomers with other ethylenically unsaturated monomers that do not contain active hydrogen groups). Prepolymers of this type are well known in the art and are described, for example, in U.S. Pat. No. 6,465,104 (incorporated herein by reference in its entirety).

The isocyanate-functionalized polyurethane prepolymer component of the present invention may be prepared by any of the synthetic methods known in the art. The equivalent ratio of NCO/active hydrogen (e.g., OH) groups from all the materials used to prepare the prepolymer should be greater than 1:1 in order to provide a prepolymer having an excess of isocyanate groups (i.e., a prepolymer containing terminal NCO groups). Typically, the NCO/active hydrogen ratio taken on an equivalents ratio is greater than about 1.2:1 or greater than about 1.5:1 or even greater than about 3:1. Generally speaking, it will be desirable to utilize a prepolymer having a free NCO content of from about 0.2 to about 20 weight percent.

In one embodiment, the adhesive of the present invention contains little or no free monomeric isocyanate. For example, the monomeric isocyanate content may be 1 weight % or less or 0.1 weight % or less. To reduce the level of free monomeric isocyanate, the isocyanate-functionalized polyurethane prepolymer may be synthesized using special techniques and/or may be subjected to a purification procedure wherein the monomeric isocyanate is removed, as is well known in the art.

The amount of isocyanate-functionalized polyurethane prepolymer in the adhesive may be varied as desired, but typically the adhesive contains from about 20 to about 99 weight % prepolymer.

The hot melt adhesives of the present invention may optionally contain one or more thermoplastic resins, in addition to the hollow polymeric microspheres and isocyanate-functionalized polyurethane prepolymers. Acrylic resins and similar materials are especially suitable for incorporation into the hot melt adhesive. The thermoplastic resin may be either non-reactive or reactive (i.e., reactive with isocyanate groups). For example, the thermoplastic resin may contain hydroxyl or other active hydrogen-containing functional groups and may therefore react to some extent with the polyisocyanates and/or the isocyanate-functionalized polyurethane prepolymer. As mentioned previously, reactive thermoplastic resins may be reacted with the polyisocyanate(s), along with other active hydrogen-containing reactants such as polyester polyols and polyether polyols, during preparation of the isocyanate-functionalized polyurethane prepolymer, as is well known in the art. Thermoplastic resins suitable for use in modifying the hot melt adhesives of the present invention are described, for example, in the following United States patents and applications (each of which is incorporated herein by reference in its entirety): U.S. Pat. Nos. 3,931,077; 5,021,507; 5,441,808; 5,550,191; 5,866,656; 5,922,805; 6,465,104; 6,482,878; 6,613,836; 2003-0004263; 2003-0010442; 2003-0212235; 2003-0213557; 2004-0198899; and 2005-0222362.

For example, the thermoplastic resin may be one or more polymers (including random and block copolymers) of ethylenically unsaturated monomers. Specific illustrative monomers suitable for the preparation of such polymers include, but are not limited to, C1-C18 alkyl esters of unsaturated carboxylic acids such as fumaric acid, maleic acid, acrylic acid or methacrylic acid, hydroxyalkylesters of acrylic acid or methacrylic acid such as hydroxypropyl acrylate or hydroxypropyl methacrylate, unsaturated carboxylic acids such as acrylic acid and methacrylic acid, vinyl ethers, olefins such as ethylene, vinyl esters such as vinyl acetate, unsaturated nitrites such as acrylonitrile and methacrylonitrile, vinyl aromatic monomers such as styrene, dienes such as butadiene and isoprene, and the like. The number average molecular weights of such polymers may, for example, be from about 2000 to about 60,000. The polymers may have hydroxyl numbers ranging from 0 to about 20 mg KOH/g, for example. Typically, the reactive polyurethane hot melt adhesive may contain from about 0.1 to about 40 weight percent of such polymers.

The hot melt adhesive according to the present invention may additionally comprise one or more of the following: catalysts, antioxidants, defoamers, stabilizers, tackifying resins, fillers, pigments, plasticizers, adhesion promoters, viscosity modifiers, waxes, flame retardants, foaming agents (including latent foaming agents), conductive agents and/or rheology improvers. In preferred embodiments, the adhesive is essentially free or entirely free of any volatile organic solvents (e.g., the adhesive contains less than 0.5 or less than 0.1 weight percent volatile organic solvents).

The optional catalysts may accelerate the formation of the polyurethane prepolymer during its production and/or the moisture curing/crosslinking process after application of the hot melt adhesive. Suitable catalysts are the normal polyurethane catalysts such as, for example, compounds of divalent and tetravalent tin, more particularly the dicarboxylates of divalent tin and the dialkyl tin dicarboxylates and dialkoxylates. Examples of such catalysts are dibutyl tin dilaurate, dibutyl tin diacetate, dioctyl tin diacetate, dibutyl tin maleate, tin(II) octoate, tin(II) phenolate as well as the acetyl acetonates of divalent and tetravalent tin. The highly effective tertiary amines or amidines may also be used as catalysts, optionally in combination with the tin compounds mentioned above. Suitable amines are both acyclic and, in particular, cyclic compounds. Examples include tetramethyl butane diamine, bis-(dimethylaminoethyl)-ether, 1,4-diazabicyclooctane (DABCO), 1,8-diazabicyclo-(5.4.0)-undecane, 2,2′-dimorpholinodiethyl ether (DMDEE) or dimethyl piperazine or even mixtures of the amines mentioned above.

“Stabilizers” in the context of the present invention include stabilizers that stabilize the viscosity of the polyurethane prepolymer during its production, storage and application. Suitable stabilizers of this type include, for example, monofunctional carboxylic acid chlorides, monofunctional highly reactive isocyanates and non-corrosive inorganic acids. Examples of such stabilizers are benzoyl chloride, toluene sulfonyl isocyanate, phosphoric acid or phosphorous acid. In addition, stabilizers in the context of the present invention include antioxidants, UV stabilizers and/or hydrolysis stabilizers. The choice of these stabilizers is determined on the one hand by the main components of the hot melt adhesive and on the other hand by the application conditions and by the conditions to which the adhesive bond is likely to be exposed. When the polyurethane prepolymer is predominantly made up of polyether units, antioxidants—optionally in combination with UV stabilizers—are often needed. Examples of suitable antioxidants include the commercially available sterically hindered phenols and/or thioethers and/or substituted benzotriazoles. In cases where key components of the polyurethane prepolymer consist of polyester units, hydrolysis stabilizers, for example of the carbodiimide type, are preferably used.

Examples of suitable tackifying resins include abietic acid, abietic acid esters, terpene resins, terpene/phenol resins, alpha-methyl styrene resins, rosin esters, and hydrocarbon resins. Examples for fillers include silicates, ceramics, glass, quartz, mica, titanium dioxide, graphite, talcum, calcium carbonates, clays or carbon black. Suitable rheology improvers imparting thixotropy or sag resistance are, for example, organically modified clays, pyrogenic (fumed) silicas, urea derivatives and fibrillated or pulp chopped fibers. Suitable plasticizers include, but are not limited to, substances which do not overly interfere with the efficacy of the other components of the adhesive but which facilitate processing and increase the toughness and flexibility of the adhesive, including liquid aromatic ester plasticizers.

Although frequently no additional adhesion promoters are required, the abovementioned tackifying resins like abietic acid, terpene resins, terpene/phenol resins or hydrocarbon resins also act as adhesive promoters. Organofunctional silanes like the epoxy-functional 3-glycidyl-oxypropyl-trialkoxysilane or the isocyanate-functional isocyanatoethyl trisalkoxysilane, epoxy resins, melamine resins or phenolic resins may also be added as adhesion promoters.

The viscosity of the reactive polyurethane hot melt adhesives according to the present invention preferably ranges from about 2,000 to about 50,000 cps at 121° C. (250° F.). Plasticizers, tackifiers and rheology control agents may be added (typically, in small amounts, e.g., less than about 10% by weight of the adhesive) to control the melt viscosity characteristics of the adhesive as may be desired. As discussed previously, the compositions of the present invention are solid at room temperature and in at least certain embodiments are not pressure sensitive or tacky at room temperature (i.e., the adhesive is not a pressure sensitive adhesive).

The adhesives of the present invention may be employed in any of the applications and end uses where reactive polyurethane hot melt adhesives are conventionally utilized. Typical applications include, but are not limited to, the laminating wood working industry including the bonding of wooden panels, the bonding of core materials (including profiled core materials) made of wood, oriented strand board, fiberboard, chipboard, particle board and the like with laminates, veneers or surface or edge coverings of plastic, wood, metal resin-coated paper and the like, the attachment of labels to containers and other substrates, automotive interior assembly (e.g., dashboard lamination, interior seating lamination, interior trim lamination), shoe assembly, profile wrapping, decorative laminating, furniture assembly, fabric and foam bonding, assembly of textile composites, coating of upholstery fabrics, roof panel bonding, fabrication of articles including nonwoven fabrics, bookbinding, fabrication of grinding discs and grinding paper and the like.

The adhesives of the present invention can generally be used in methods for bonding substrates together, wherein a portion of the reactive polyurethane hot melt adhesive is applied in a liquid melt form to a first article, a second substrate (which may or may not also have a portion of the adhesive deposited thereon) is brought in contact with the adhesive on the first substrate (preferably, while the adhesive is still liquid or at least not fully solidified), and the adhesive then allowed to cool and cure to yield a composition which is thermoset or cross-linked in character (i.e., having an irreversible solid form). Such curing is carried out in the presence of moisture, which reacts with the free isocyanate groups of the prepolymer component. The adhesives of the present invention thus do not need to be combined with any substance such as an organic curative prior to use, as the moisture reaction is sufficient to cure the adhesive. The moisture may be intentionally introduced (e.g., on the surfaces of the substrates to be bonded and/or in the atmosphere to which the joined substrates are exposed during curing, by means such as spraying, misting, or the like), although often the amounts of ambient moisture present on the substrate surfaces or in the atmosphere will be sufficient to induce curing of the adhesive. The adhesives of the present invention are typically produced and stored in the absence of moisture (e.g., the adhesives are essentially anhydrous). When it is desired to use the adhesive (which is generally distributed and stored in solid form), the adhesive is heated and melted prior to application to a substrate. Any of the application techniques for reactive polyurethane hot melt adhesives known in the art can generally also be utilized for the adhesives of the present invention, although normally it will be desirable to avoid conditions which will result in permanent collapse or severe deformation of the hollow polymeric microspheres such as extremely high temperatures and/or high shear. However, the temperature of the adhesive should be high enough to achieve a suitable workable viscosity for the application method being employed. The optimum temperature thus will depend upon a number of factors, including the softening or melt temperature of the hollow polymeric microspheres and the melt Theological properties of the isocyanate-functionalized polyurethane prepolymer and other components of the adhesive, but typical useful temperatures will be in the range of from about 40 degrees C. to about 200 degrees C. or from about 50 degrees C. to about 160 degrees C. or from about 90 degrees C. to about 140 degrees C. Application of the adhesive to a substrate may be effected by means such as heated spray applicators, heated bead applicators, heated nozzles, and heated roll coaters. The coating, bead or film of adhesive on the substrate surface may be continous or discontinuous. The amount of adhesive used will vary considerably depending upon the substrates as well as other factors, but typically will be from about 1 to about 250 g/m². The substrates to be joined by the adhesive may be pressed together to assure good contact between the substrates and the adhesive. In one embodiment of the invention, the substrates are pressed together before the adhesive is completely solidified. In another embodiment, the adhesive can be applied to a substrate surface in melt (liquid) form, cooled until solidified, and then reheated (remelted) shortly before or while being pressed into contact with the surface of a second substrate.

Substrates capable of being bonded to each other using the adhesives of the present invention include, but are not limited to, plastic (including foamed plastics), wood (including consolidated or composite wood products), metal, glass, ceramics, paper (and other cellulosic substrates), fabric (textiles), plasterboard, sheet rock, and the like. The substrates bonded to each other may be the same as or different from each other. In certain embodiments, the substrates that are bonded together are relatively thin and flat; in such cases, the resulting composite is often referred to in the art as a laminate or laminated structure.

### EXAMPLES

A commercial reactive polyurethane hot melt adhesive containing an isocyanate-functionalized polyurethane prepolymer (QR-4668, sold by Henkel Corporation) was modified by the addition of 1 to 5 weight % hollow polymeric microspheres (DUALITE E-136-040D, sold by Sovereign Specialty Chemicals). The microspheres are pre-expanded and have an adherent coating of particulate calcium carbonate, a composite density of 0.136 g/cm³, and a particle size of about 30 to about 50 microns.

When 1 weight % of the microspheres was added to the reactive polyurethane hot melt adhesive (Example 2), the adhesive viscosity at 121° C. increased about 57%, the cross peel strength (after 5 minutes) increased about 34%, the density of the adhesive decreased about 9%, and the open time decreased about 36%, as compared to the control adhesive containing no microspheres (Example 1). At a microsphere content of 5 weight % (Example 4), the adhesive viscosity at 121° C. increased about 276%, the cross peel strength (after 5 minutes) increased about 148%, the density of the adhesive decreased about 23%, and the open time decreased about 64%, as compared to the control adhesive containing no microspheres. Open time was measured by preheating the adhesive to 149° C. (300° F.), applying the heated adhesive to luwan board (the board being at room temperature), applying a tongue depressor by hard pressing against the adhesive, and then pulling off the tongue depressor.

TABLE I

| | Example 1 | | | |
|---|---|---|---|---|
| | (Control) | Example 2 | Example 3 | Example 4 |
| Wt. % | 0 | 1 | 3 | 5 |
| Microspheres | | | | |
| Open Time | 5.5 | 3.5 | 2.5 | 2 |
| (min) | | | | |
| Viscosity | 12,750 | 20,000 | 32,000 | 48,000 |
| @121° C. (cps) | | | | |
| Density (g/mL) | 1.06 | 0.96 | 0.89 | 0.82 |

TABLE II
(Cross Peel Strength, psi)

| Time | Example 1 | | | |
|---|---|---|---|---|
| (min) | (Control) | Example 2 | Example 3 | Example 4 |
| 0 | 0 | 0 | 0 | 0 |
| 5 | 33.7 | 45 | 79 | 83.7 |
| 8 | 58 | 99.7 | 111 | 104 |
| 11 | 126 | 128.7 | 131.7 | 150 |
| 14 | 171 | 165 | 124.3 | 148 |
| 17 | 140 | 173 | 161.7 | 138 |
| 20 | 175 | 145 | 149 | 135 |

What is claimed is:

1. A solvent-free moisture-curing polyurethane hot melt adhesive composition, comprising:
a) at least one isocyanate-functionalized polyurethane prepolymer; and
b) hollow polymeric microspheres.

2. The hot melt adhesive composition of claim 1 comprising from about 0.2 to about 10 weight percent hollow polymeric microspheres.

3. The hot melt adhesive composition of claim 1, wherein said hollow polymeric microspheres have shells comprised of thermoplastic polymer.

4. The hot melt adhesive composition of claim 1, wherein said hollow polymeric microspheres are thermally clad.

5. The hot melt adhesive composition of claim 1, wherein said hollow polymeric microspheres have a density of not greater than about 0.04 g/cm³, as calculated in the absence of any material that may be coated on the outside surface of said hollow polymeric microspheres.

6. The hot melt adhesive composition of claim 1, wherein said hollow polymeric microspheres have an outer coating comprised of finely divided particles and have a composite density of not greater than about 0.3 g/cm³, as measured including the outer coating.

7. The hot melt adhesive composition of claim 1, wherein said hollow polymeric microspheres have an outer coating adhered or embedded thereto comprised of finely divided particles having an average particle size that is less than the average particle size of said hollow polymeric microspheres.

8. The hot melt adhesive composition of claim 1, wherein said hollow polymeric microspheres are comprised of a polymeric shell and an outer coating comprised of a free flowing solid having a softening or melting point at a temperature above that of the polymeric shell.

9. The hot melt adhesive composition of claim 1, wherein said hollow polymeric microspheres have an outer coating comprised of finely divided particles of at least one barrier material selected from the group consisting of talc, titanium dioxide and calcium carbonate.

10. The hot melt adhesive composition of claim 1, wherein said hollow polymeric microspheres have an average particle size of from about 5 to about 500 microns.

11. The hot melt adhesive composition of claim 1, wherein said hollow polymeric microspheres are non-expandable.

12. The hot melt adhesive composition of claim1,wherein said hollow polymeric microspheres have an average particle size of from about 20 to about 60 microns.

13. The hot melt adhesive composition of claim 1, wherein said hollow polymeric microspheres have shells comprised of a polymer selected from the group consisting of methyl methacrylate-acrylonitrile copolymers, vinylidene chloride-acrylonitrile copolymers and vinylidene chloride-acrylonitrile-methyl methacrylate copolymers.

14. The hot melt adhesive composition of claim 1, wherein said hollow polymeric microspheres are comprised of a polymer obtained by polymerization of one or more monomers selected from the group consisting of vinylidene chloride and acrylonitrile, optionally in combination with one or more other ethylenically unsaturated monomers.

15. The hot melt adhesive composition of claim 1, wherein said hollow polymeric microspheres are stable at temperatures of at least about 160° C.

16. The hot melt adhesive composition of claim 1, additionally comprising at least one catalyst.

17. The hot melt adhesive composition according to claim 1, additionally comprising at least one tertiary amine catalyst.

18. The hot melt adhesive composition according to claim 1, additionally comprising at least one additive selected from the group consisting of reactive and non-reactive thermoplastic resins, tackifiers, plasticizers, fillers, pigments, stabilizers, adhesion promoters, flame retardants, conductive agents, rheology improvers, and mixtures thereof.

19. A process for joining a first substrate to a second substrate, comprising joining said first substrate and said second substrate with the hot melt adhesive composition of claim 1.

20. A process for bonding a first substrate to a second substrate, said process comprising applying the hot melt adhesive composition of claim 1 in melted form to a surface of said first substrate, contacting a surface of said second substrate to the surface of said first substrate having the hot melt adhesive composition applied thereon while the hot melt adhesive composition is still in melted form, cooling the hot melt adhesive composition until solidification of the hot melt adhesive takes place, and exposing the hot melt adhesive composition to water in an amount effective to cross-link the isocyanate-functionalized polyurethane prepolymer.
